(19) United States
(12) Patent Application Publication
(10) Pub. No.: US 2009/0066812 A1
(43) Pub. Date: Mar. 12, 2009

(54) FRAME DATA CREATION METHOD AND APPARATUS, FRAME DATA CREATION PROGRAM, AND PLOTTING METHOD AND APPARATUS

(76) Inventors: Daisuke Nakaya, Kanagawa-ken (JP); Naozumi Jogo, Kanagawa-ken (JP); Takayuki Uemura, Kanagawa-ken (JP); Kazuki Yamamoto, Kanagawa-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 11/813,704

(22) PCT Filed: Jan. 6, 2006
(86) PCT No.: PCT/JP2006/300318

§ 371 Date: Jul. 11, 2007

(30) Foreign Application Priority Data
Jan. 11, 2005 (JP) 2005-004004

(51) Int. Cl. H04N 5/76

(52) U.S. Cl. 348/231.99; 348/E09.002

(57) ABSTRACT

A method for creating frame data used when forming an image by moving a spatial light modulation device including a plurality of plotting element arrays in a scanning direction which forms an inclination angle θ with an arrangement direction of the plotting element arrays, and sequentially inputting the frame data to the spatial light modulation device according to the movement of the device in the scanning direction. The method is based on image data in which pixel data are disposed two-dimensionally in a sub-scanning direction corresponding to the scanning direction, and a main scanning direction orthogonal to the sub-scanning direction, and the frame data are created after performing a deformation process on the image data such that the pixel data corresponding to each of the plotting element arrays (e.g., circled numbers 1 to 6) are disposed in the main scanning direction.

### TECHNICAL FIELD

The present invention relates to a frame data creation method, apparatus, and program for creating frame data used when forming an image by moving a plot point creation unit, which includes a spatial light modulation device or the like, relative to a plotting surface in a predetermined scanning direction. It also relates to a plotting method and apparatus for performing a plotting operation using frame data created by the frame data creation method, apparatus, and program.

### BACKGROUND ART

Various types of plotting systems that form intended two-dimensional patterns on plotting surfaces based on image data are known.

As such plotting systems, various types of exposure system for performing exposure by modulating a light beam according to image data using a spatial light modulation device, such as a digital micro-mirror device (DMD) or the like are proposed. The DMD includes multitudes of tiny micro-mirrors arranged two-dimensionally on memory cells (SRAM arrays) formed on a semiconductor substrate made of, for example, silicon or the like, and the angle of the reflection surface of the mirror is changed by tilting the mirror through controlling electrostatic force provided by the charges stored in the memory cell. A plot point is formed on an intended position by the change in the angle of the reflection surface, thereby an image is formed.

As for exposure systems that employ a DMD like that as described above, an exposure system for forming an intended image on an exposure surface is proposed, in which, for example, the DMD is moved relative to the exposure surface in a predetermined scanning direction, and frame data including multitudes of plot point data corresponding to multitudes of micro-mirrors are inputted to the memory cells of the DMD according to the movement of the DMD in the scanning direction, thereby plot points corresponding to the micro-mirrors of the DMD are formed sequentially in time series manner and the intended image is formed on the exposure surface.

Generally, micro-mirrors of the DMD are disposed such that the arrangement direction of the micro-mirrors in each row is orthogonal to the arrangement direction thereof in each column. An exposure system, in which exposure is performed by inclining the DMD by a predetermined angle with respect to the scanning direction so that the scanning lines scanned by the micro-mirrors become close with each other in order to improve the resolution of an image formed on an exposure surface, is proposed as described, for example, in Japanese Unexamined Patent Publication No. 2004-009595.

Here, when performing exposure using the exposure system described above, it is necessary to sequentially input frame data to the DMD according to the relative movement of the DMD in the scanning direction. Thus, it is necessary to provide a plurality of groups of frame data, each corresponding to the position of the DMD with respect to the exposure surface prior to performing the exposure.

When providing the groups of frame data described above, for example, the following steps have been used. That is, tentatively storing image data representing an image to be exposed on an exposure surface in a memory, such as DRAM or the like, then, for each position of the DMD with respect to the exposure surface, sequentially reading out pixel data corresponding to each of the micro-mirrors of the DMD from the memory to obtain data of each plot point to be inputted to each of the micro-mirrors of the DMD, and creating each group of frame data from the obtained plot point data.

However, as illustrated in FIG. 18, the image data 1 include pixel data 5 which are arranged two-dimensionally in the sub-scanning direction corresponding to the scanning direction of the DMD and the main scanning direction orthogonal to the sub-scanning direction. Here assuming, for example, the case where the frame data are created for an exposure system in which the DMD is inclined by a predetermined angle with respect to the scanning direction as described above, and image data disposed, for example, in the main scanning direction shown in FIG. 18 are stored at consecutive addresses in the memory. In this case, each address of pixel data corresponding to each micro-mirror is distributed discretely in the address space viewed from a control means for controlling the memory. Under this situation, if pixel data corresponding to each micro-mirror is sequentially read out, the image data need to be read out by gaining access to the discrete addresses one by one, which is very time consuming in terms of memory control, so that it will take a very long time to obtain all of the frame data.

In view of the circumstances described above, it is an object of the present invention to provide a frame data creation method, apparatus and program capable of creating frame data like those described above in a shorter time. It is a further object of the present invention to provide a plotting method and apparatus employing the aforementioned present invention.

### DISCLOSURE OF THE INVENTION

The frame data creation method of the present invention is a frame data creation method for use in combination with a plot point forming unit which includes a plurality of plotting element arrays disposed in parallel with each other, each having a plurality of plotting elements disposed in a line for forming plot points on a plotting surface, to create frame data including a plurality of plot point data, each corresponding to each of the plotting elements, used when forming an image constituted by a plurality of plot points disposed two-dimensionally on the plotting surface by moving the plot point forming unit relative to the plotting surface in a scanning direction which forms a predetermined inclination angle θ (0°<θ<90°) with an arrangement direction of the plotting element arrays, and sequentially inputting the frame data to the plot point forming unit according to the movement thereof in the scanning direction to sequentially form a group of plot points in time series manner, wherein the frame data are created by obtaining the plurality of plot point data based on image data representing the image in which pixel data corresponding to the plot point data are disposed two-dimensionally in a sub-scanning direction, which corresponds to the scanning direction, and a main scanning direction, which is orthogonal to the sub-scanning direction, the method including the steps of:

performing a deformation process on the image data such that the pixel data corresponding to each of the plotting element arrays in the image data are disposed in the main scanning direction; and

creating the frame data by obtaining the plurality of plot point data based on the deformed image data.

In the frame data creation method described above, an arrangement may be adopted in which the method further includes the step of storing the pixel data in a memory means to which the deformed image data are stored such that a direction in which addresses of the memory means are arranged serially corresponds to an arrangement direction according which the pixel data corresponding to each of the plotting element arrays are stored, and the plurality of plot point data are obtained by reading out the stored pixel date from the memory means.

Further, the deformation process may be performed by shifting each of the pixel data corresponding to each of the plotting elements of the plotting element array in the sub-scanning direction according to the inclination angle.

Still further, an arrangement may be adopted in which the method further includes the step of sorting the pixel data with respect to the scanning direction such that pixel data belonging to a same frame data group, each corresponding to each of the plotting elements of each of the plotting element arrays, are disposed serially in the main scanning direction, and the frame data are created based on the post-sorting deformed image data.

Further, when the resolution of the image data is lower than that of the image to be plotted on the plotting surface, an arrangement may be adopted in which the method further includes the step of generating the plot point data, each corresponding to each of the plotting elements, using each of the pixel data of the post-sorting deformed image data a plurality of times, and the frame data are created using the generated plot point data.

Still further, when the plot point forming unit is divided into a plurality of segmented regions, and multiple plotting is performed by the plurality of segmented regions, an arrangement may be adopted in which the method further includes the step of shifting the post-sorting deformed image data corresponding to each of the segmented regions to the main scanning direction according to the order of the multiple plotting, and the frame data are created based on the shifted post-sorting deformed image data.

The plotting method of the present invention is a plotting method including the steps of:

obtaining each of the frame data groups using the frame data creation method described above; and

forming the image on the plotting surface by moving the plot point forming unit relative to the plotting surface in the scanning direction, and sequentially inputting each group of the frame data to the plot point forming unit according to the movement thereof in the scanning direction to sequentially form the group of plot points in time series manner.

The frame data creation apparatus of the present invention is a frame data creation apparatus for use in combination with a plot point forming unit which includes a plurality of plotting element arrays disposed in parallel with each other, each having a plurality of plotting elements disposed in a line for forming plot points on a plotting surface, to create frame data including a plurality of plot point data, each corresponding to each of the plotting elements, used when forming an image constituted by a plurality of plot points disposed two-dimensionally on the plotting surface by moving the plot point forming unit relative to the plotting surface in a scanning direction which forms a predetermined inclination angle θ (0°<θ<90°) with an arrangement direction of the plotting element arrays, and sequentially inputting the frame data to the plot point forming unit according to the movement thereof in the scanning direction to sequentially form a group of plot points in time series manner, wherein the frame data are created by obtaining the plurality of plot point data based on image data representing the image in which pixel data corresponding to the plot point data are disposed two-dimensionally in a sub-scanning direction, which corresponds to the scanning direction, and a main scanning direction, which is orthogonal to the sub-scanning direction, the apparatus including:

an image data deformation unit for performing a deformation process on the image data such that the pixel data corresponding to each of the plotting element arrays in the image data are disposed in the main scanning direction; and

a frame data creation unit for creating the frame data by obtaining the plurality of plot point data based on the deformed image data deformed by the image data deformation unit.

The frame data creation apparatus described above may further includes: a memory means for storing the deformed image data; and a memory control means for storing the pixel data in the memory means such that a direction in which addresses of the memory means are arranged serially corresponds to an arrangement direction according which the pixel data corresponding to each of the plotting element arrays are stored, and the frame data creation unit may be a unit for reading out from the memory means the pixel data stored therein to obtain the plurality of plot point data.

Further, the image data deformation unit may be a unit for shifting each of the pixel data corresponding to each of the plotting elements of each of the plotting element arrays in the sub-scanning direction according to the inclination angle.

Still further, the apparatus may further includes a pixel data sorting unit for sorting the pixel data with respect to the scanning direction such that pixel data belonging to a same frame data group, each corresponding to each of the plotting elements of each of the plotting element arrays, are disposed serially in the main scanning direction, and the frame data creation unit may be a unit for creating the frame data based on the post-sorting deformed image data.

Further, when the resolution of the image data is lower than that of the image to be plotted on the plotting surface, the frame data creation unit may be a unit for generating the plot point data corresponding to each of the plotting elements using each of the pixel data of the post-sorting deformed image data a plurality of times, and creating the frame data using the generated plot point data.

Still further, when the plot point forming unit is divided into a plurality of segmented regions, and multiple plotting is performed by the plurality of segmented regions, the frame data creation unit may be a unit for shifting the post-sorting deformed image data corresponding to each of the segmented regions to the main scanning direction according to the order of the multiple plotting, and creating the frame data based on the shifted post-sorting deformed image data.

The plotting apparatus of the present invention is a plotting apparatus, including:

the frame data creation apparatus described above;

a plot point forming unit for forming a group of plot points constituted by a plurality of plot points on a plotting surface based on the frame data inputted thereto;

a moving means for moving the plot point forming unit relative to the plotting surface in the scanning direction; and

an image forming control unit for sequentially inputting frame data created by the frame data creation apparatus to the plot point forming unit according to the movement of the plot point forming unit in the scanning direction moved by the moving means, and causing the plot point forming unit to form an image constituted by a plurality of plot points disposed two-dimensionally on the plotting surface by forming the group of plot points in time series manner.

The frame data creation program of the present invention is a frame data creation program for causing a computer to perform a method for use in combination with a plot point forming unit which includes a plurality of plotting element arrays disposed in parallel with each other, each having a plurality of plotting elements disposed in a line for forming plot points on a plotting surface, to create frame data including a plurality of plot point data, each corresponding to each of the plotting elements, used when forming an image constituted by a plurality of plot points disposed two-dimensionally on the plotting surface by moving the plot point forming unit relative to the plotting surface in a scanning direction which forms a predetermined inclination angle θ (0°<θ<90°) with an arrangement direction of the plotting element arrays, and sequentially inputting the frame data to the plot point forming unit according to the movement thereof in the scanning direction to sequentially form a group of plot points in time series manner, wherein the frame data are created by obtaining the plurality of plot point data based on image data representing the image in which pixel data corresponding to the plot point data are disposed two-dimensionally in a sub-scanning direction, which corresponds to the scanning direction, and a main scanning direction, which is orthogonal to the sub-scanning direction, wherein the program causes the computer to perform the steps of:

performing a deformation process on the image data such that the pixel data corresponding to each of the plotting element arrays in the image data are disposed in the main scanning direction; and

creating the frame data by obtaining the plurality of plot point data based on the deformed image data.

The frame data creation program described above may be a program for causing the computer: to further perform the step of storing the pixel data in a memory means to which the deformed image data are stored such that a direction in which addresses of the memory means are arranged serially corresponds to an arrangement direction according which the pixel data corresponding to each of the plotting element arrays are stored; and to perform the step of obtaining the plurality of plot point data by reading out the stored pixel data from the memory means.

Further, the deformation process may be performed by shifting each of the pixel data corresponding to each of the plotting elements of each of the plotting element arrays in the sub-scanning direction according to the inclination angle.

Still further, when the resolution of the image data is lower than that of the image to be plotted on the plotting surface, the program may be a program for causing the computer: to further perform the step of generating the plot point data, each corresponding to each of the plotting elements, using each of the pixel data of the post-sorting deformed image data a plurality of times; and to perform the step of creating the frame data using the generated plot point data.

Further, when the plot point forming unit is divided into a plurality of segmented regions, and multiple plotting is performed by the plurality of segmented regions, the program may be a program for causing the computer: to further perform the step of shifting the post-sorting deformed image data corresponding to each of the segmented regions to the main scanning direction according to the order of the multiple plotting; and to perform the step of crating the frame data based on the shifted post-sorting deformed image data.

The referent of “inclination angle” as used herein means is a smaller angle of the angles formed between the arrangement direction of the plotting element arrays and the scanning direction.

The referent of “direction in which addresses of the memory means are arranged serially” as used herein means a direction in which addresses of memory space viewed from a control means, such as CUP, that controls storage and reading out of the pixel data from the memory means are arranged serially.

The referent of “multiple plotting” as used herein means a plotting method in which plot points on the same scanning line are sequentially plotted by a plurality of corresponding plotting elements of the respective segmented regions.

The referent of “shifting the post-sorting deformed image data corresponding to each of the segmented regions to the main scanning direction according to the order of the multiple plotting” as used herein means shifting the post-sorting deformed image data such that the amount of shift becomes greater for the segmented region in the order of plotting. Thus, the post-sorting deformed image data corresponding to the segmented region that performs the plotting operation first are not necessarily shifted, and the amount of shift may be set to “0”.

According to the frame data creation method, apparatus and program, and the plotting method and apparatus using the frame data creation method, apparatus and program of the present invention, a deformation process is performed on the image data such that the pixel data corresponding to each of the plotting element arrays in the image data are disposed in the main scanning direction, and the frame data are created based on the deformed image data. If, for example, an arrangement is adopted, therefore, in which the pixel data are stored in a memory means to which the deformed image data are stored such that a direction in which addresses of the memory means are arranged serially corresponds to an arrangement direction according which the pixel data corresponding to each of the plotting element arrays are stored, and the plurality of plot point data are obtained by reading out the stored pixel data from the memory means, the pixel data may be read out rapidly, and the frame data may be created in a short time.

Further, if an arrangement is adopted in which the pixel data are sorted, with respect to the scanning direction, such that pixel data belonging to a same frame data group, each corresponding to each of the plotting elements of each of the plotting element arrays, are disposed serially in the main scanning direction, and the frame data are created based on the post-sorting deformed image data, the pixel data belonging to the same frame data group may be read out in bulk by, for example, burst transfer or the like, so that the pixel data may be read out more rapidly, and the frame data may be created in a shorter time.

Still further, when the resolution of the image data is lower than that of the image to be plotted on the plotting surface, if an arrangement is adopted in which the plot point data, each corresponding to each of the plotting elements, are generated using each of the pixel data of the post-sorting deformed image data a plurality of times, and the frame data are created using the generated plot point data, the capacity of the memory means for storing the image data may be reduced, thereby cost reduction will be achieved. At the same time, the readout speed from the memory means may be increased, so that the frame data may be created in a shorter time.

### BRIEF DESCRIPTION OF THE DRAWINGS

FIG. 1 is a perspective view of an exposure apparatus that employs an embodiment of the plotting apparatus of the present invention, illustrating the external view thereof.

FIG. 2 is a perspective view of a scanner used in the exposure apparatus shown in FIG. 1, illustrating the structure thereof.

FIG. 3A is a plan view of a photosensitive material, illustrating exposed regions formed thereon.

FIG. 3B illustrates the arrangement of exposing area of each of the exposing heads.

FIG. 4 is a partial enlarged view of a DMD used in the exposure apparatus shown in FIG. 1, illustrating the structure thereof.

FIG. 5A is a perspective view of a DMD, illustrating an operation thereof.

FIG. 5B is a perspective view of a DMD, illustrating an operation thereof.

FIG. 6 illustrates the exposure path of each of the micro-mirrors of the DMD.

FIG. 7 is a block diagram illustrating an electrical configuration in the exposure apparatus shown in FIG. 1.

FIG. 8 illustrates the relationship between each of the pixel data of image data and each of the micro-mirrors to which each of the pixel data is inputted.

FIG. 9 illustrates an example of deformed image data.

FIG. 10 illustrates an example of sorted image data.

FIG. 11 illustrates a hardware configuration of a pixel data sorting unit.

FIG. 12 illustrates frame data created in the exposure apparatus shown in FIG. 1.

FIG. 13 illustrates a method for creating frame data used in the case where the resolution of image data is lower than that of an image to be exposed.

FIG. 14 illustrates a method for creating frame data used in the case where the resolution of image data is lower than that of an image to be exposed.

FIG. 15 illustrates frame data used in the case where the resolution of image data is lower than that of an image to be exposed.

FIG. 16 illustrates multiple exposures.

FIG. 17 illustrates a method for creating frame data used when performing multiple exposures.

FIG. 18 illustrates a conventional method for creating frame data.

### BEST MODE FOR CARRYING OUT THE INVENTION

Hereinafter, an exposure apparatus that employs an embodiment of a frame data creation method, apparatus and program, and plotting method and apparatus of the present invention will be described in detail with reference to the accompanying drawings.

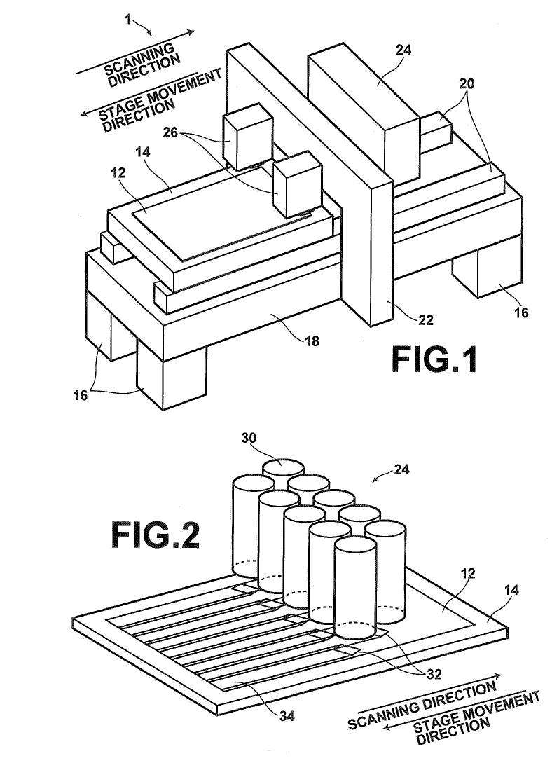

The exposure apparatus is an apparatus that uses a DMD as a plot point forming unit of the present invention, and has characteristic features in the method for creating frame data to be inputted to the DMD. But, the overall structure of the exposure apparatus of the present embodiment will be described first. FIG. 1 is a perspective view of the exposure apparatus of the present embodiment, illustrating a schematic structure thereof.

As shown in FIG. 1, the exposure apparatus 10 of the present embodiment includes a plate-like moving stage 14 for holding a photosensitive material 12 thereon by suction. Two guides 20 extending along the moving direction of the stage are provided on the upper surface of a thick plate-like mounting platform 18 which is supported by four legs 16. The stage 14 is arranged such that its longitudinal direction is oriented to the moving direction of the stage, and movably supported by the guides 20 to allow back-and-forth movements.

An inverse U-shaped gate 22 striding over the moving path of the moving stage 14 is provided at the central part of the mounting platform 18. Each of the ends of the inverse U-shaped gate 22 is fixedly attached to each of the sides of the mounting platform 18. A scanner 24 is provided on one side of the gate 20, and a plurality of sensors 26 (e.g. two) for detecting the front and rear edges of the photosensitive material 12 is provided on the other side. The scanner 24 and sensors 26 are fixedly attached to the gate 22 over the moving path of the stage 14. The scanner 24 and sensors 26 are connected to an overall control unit that controls them, which will be described later.

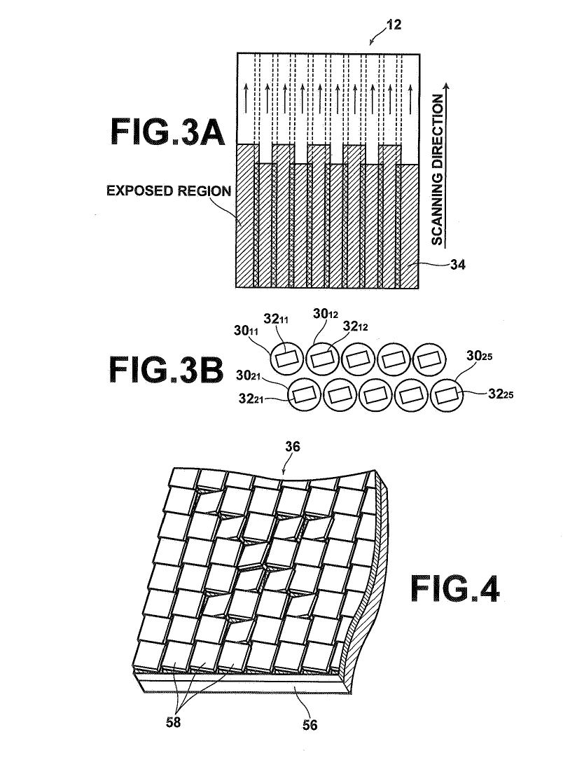

As shown in FIGS. 2 and 3B, the scanner 24 has ten exposing heads 30 disposed in substantially a matrix form of two rows with five columns. Hereinafter, the exposing head disposed at the n^{th} column of the m^{th} row will be designated as the exposing head 30ₘₙ.

Each exposing head 30 includes a digital micro-mirror device (DUD) 36, which is a spatial light modulation device. The DMD 36 includes a plurality of micro-mirror arrays disposed parallel with each other, each array having micro-mirrors serving as the plotting elements arranged linearly. The DMD 36 is attached to the exposure head 30 such that the arrangement direction of the micro-mirror arrays forms a predetermined angle with the scanning direction. Accordingly, exposing area 32 of each of the exposing heads 30 has a rectangular shape which is inclined with respect to the scanning direction as illustrated in FIGS. 2 and 3B. Hereinafter, the exposing area of the exposing head disposed at the n^{th} column of the m^{th} array will be designated as the exposing area 32ₘₙ.

A fiber array light source (not shown) with the luminous points being arranged linearly in the direction corresponding to the direction of the long side of the exposing area 32, and a condenser lens system (not shown) for collimating the laser beams outputted from the fiber array light source and focusing the collimated laser beams on the DMD 36, after the collimated laser beams are corrected to provide uniformly distributed luminous energies, are provided on the light entry side of the DMD 36.

An imaging lens system (not shown) for focusing an image on the plotting surface of the photosensitive material 12 is disposed on the light reflecting side of the DMD 36.

As shown in FIG. 3A, a stripe-shaped exposed region 34 is formed on the photosensitive material 12 by each of the exposing heads 30 as the stage 14 moves. Each of the exposing heads 30 arranged linearly in a row is displaced by a predetermined distance in the arranging direction from each of the corresponding exposing heads 30 arranged linearly in another row such that each of the stripe-shaped exposed regions 34 partly overlaps with the adjacent exposed regions 34. Consequently, the unexposed portion of the photosensitive material which corresponds to the space between the exposing areas 32₁₁, and 32₁₂ in the first row may be exposed by the exposing area 32₂₁ in the second row.

The DMD 36 includes micro-mirrors 58, each supported by a support post on a SRAM of SRAM arrays (memory cell) 56 as shown in FIG. 4. It is a mirror-device that includes a multitude (e.g., 13.68 μm pitch, 1024×768) of micro-mirrors 58 disposed two dimensionally in orthogonal directions. As described above, silicon-gate CMOS SRAM arrays 56, which may be produced by a manufacturing line for general semiconductor memories, are provided beneath the micro-mirrors 58 through the support posts, each including a hinge and yoke.

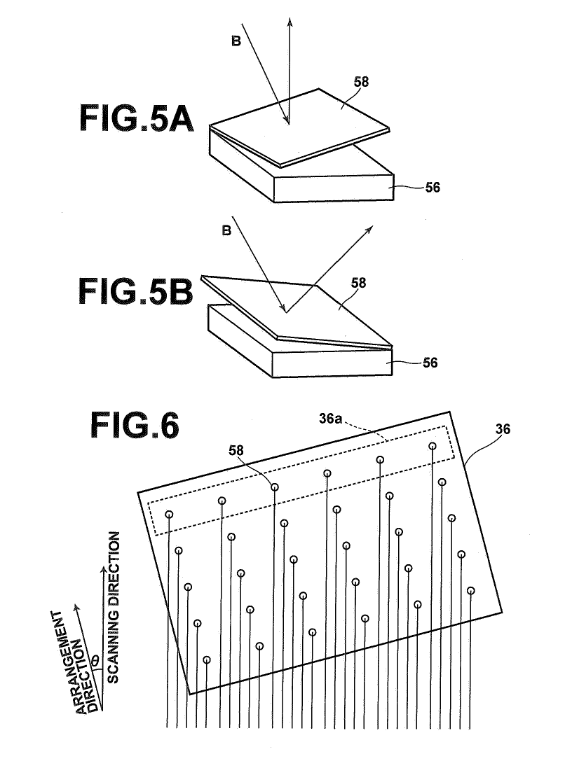

When digital signals serving as control signals are written into the SRAM arrays 56 of the DMD 36, a control voltage is applied to an electrode unit (not shown) of each of the micro-mirrors 58 in accordance with the digital signal. Then, each of the micro-mirrors 58 supported by each of the support post is tilted within the range of ±α degrees (e.g., ±10 degrees) centered on the diagonal line by the electrostatic force developed by the applied voltage. FIG. 5A shows one of the micro-mirrors 58 tilted by +α degrees, which means that it is in on-state, and FIG. 5B shows one of the micro-mirrors 58 tilted by −α degrees, which means that it is in off-state. The light beam B inputted to one of the micro-mirrors 58 when it is in on-state is reflected toward the photosensitive material 12, and the light beam B inputted to one of the micro-mirrors 58 when it is in off-state is reflected toward a light absorption material other than the photosensitive material 12. Then, one plot point that forms a part of a target exposure image is exposed on the photosensitive material 12 when the light beam B reflected by one of the micro-mirrors 58 is irradiated on the photosensitive material 12.

Further, in the exposure apparatus 10, the DMD 36 is attached to the exposure head 30 such that the arrangement direction 36a of the micro-mirrors 58 forms a predetermined inclination angle θ (0°<θ<90°) with the scanning direction, so that the exposure spot of each micro-mirror 58 becomes like that illustrated in FIG. 6, which allows the exposure to be performed at a narrower pitch than the arrangement pitch of the micro-mirrors 58.

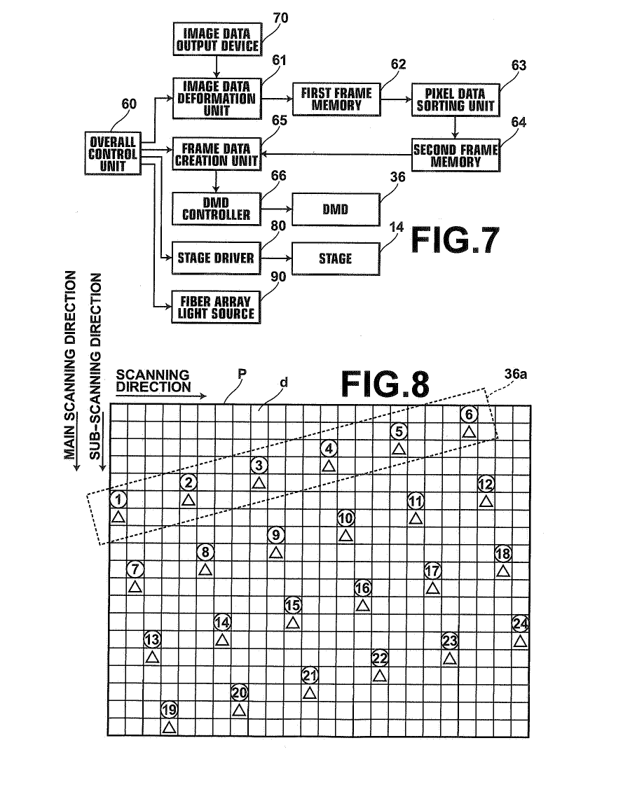

As shown in FIG. 7, the exposure apparatus includes: an image data deformation unit 61 that accepts image data outputted from an image data output device 70, and performs deformation on the accepted image data; a first frame memory 62 to which the deformed image data deformed by the image data deformation unit 61 are tentatively stored; and a pixel data sorting unit 63 that performs sorting on the deformed image data stored in the first frame memory 62. The apparatus further includes: a second frame memory 64 to which the sorted image data sorted by the pixel data sorting unit 63 are tentatively stored; a frame data creation unit 65 that creates frame data based on the sorted image data stored in the second frame memory 64; a DMD controller 66 that outputs control signals to the DMD 36 based on the frame data outputted from the frame data creation unit 65; and an overall control unit 60 that controls the entire exposure apparatus. The image data deformation unit 61, pixel data sorting unit 63, and frame data creation unit 65 include programs for performing predetermined procedures, and the overall control unit 60 controls the operation of the apparatus according to the procedures performed by the programs. The predetermined procedure performed by each program will be described later. The overall control unit 60 also controls operations of a stage driver 80 that drives the stage 14, and a fiber array light source 90.

As for the first frame memory 62 and second frame memory 64, for example, MRAM, FRAM, as well as DRAM may be used. That is, any type of memory may be used as long as it allows stored data to be sequentially read out in the direction in which the addresses thereof are arranged sequentially. Further, a memory in which stored data are read out through a so-called burst transfer may also be used.

An operation of the exposure apparatus 10 will now be described.

First, image data corresponding to an image to be exposed on the photosensitive material 12 are generated by the image data output device 70, including a computer or the like, and outputted to the exposure apparatus 10, which is received by the image data deformation unit 61.

Here, image data D inputted to the image data deformation unit 61 include multitudes of pixel data d disposed two-dimensionally in the main scanning direction and sub-scanning direction, which is orthogonal to the main scanning direction, as illustrated in FIG. 8. The circled numbers 1 to 24 schematically represent the micro-mirrors 58 of the DMD 36. FIG. 8 illustrates the relationship between each of the pixel data d and each of the micro-mirrors 58 to which each of the pixel data d is inputted. Each of the grids shown in FIG. 8 represents each of the pixel data, and at the same time, represents a pixel constituting an image exposed on the photosensitive material 12. The image data D are generated such that the scanning direction shown in FIG. 1 corresponds to the sub-scanning direction described above, as illustrated in FIG. 8. The triangle marks in FIG. 8 indicate the locations of the micro-mirrors 58 when the DMD 36 is moved by one pixel in the scanning direction. That is, one group of frame data is created by the pixel data d corresponding to the circled numbers 1 to 24 in FIG. 8, and another group of next frame data following thereof is created by the pixel data d corresponding to the triangle marks. In the present embodiment, the resolution of the image data D is greater than that of the micro-mirrors 58 of the DMD 36, as illustrated in FIG. 8.

Here, the arrangement direction 36a of the micro-mirrors 58 is inclined with respect to the scanning direction of the DMD 36 (sub-scanning direction of the image data D) as described above, if each group of frame data is created directly from the image data structured in the manner as described above, then the pixel data d corresponding to each of the micro-mirrors 58, will need to be read out discretely from the memory storing the image data, which is time consuming as described above, so that it will take a very long time to create each frame data group.

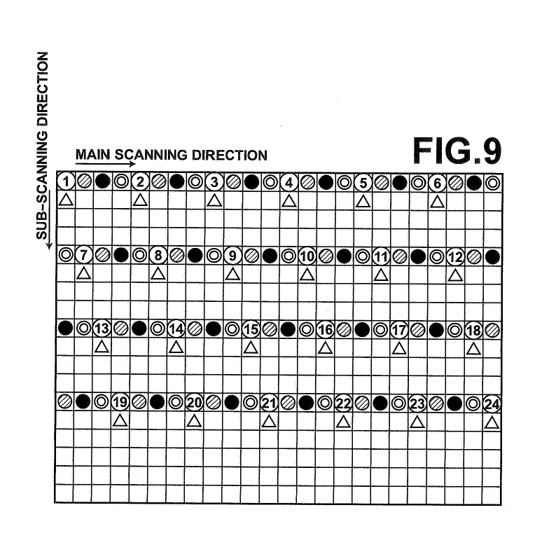

As such, in the exposure apparatus 10 of the present embodiment, a deformation process is performed on the image data in the image data deformation unit 61. More specifically, as illustrated in FIG. 9, the deformation process is performed on the image data such that the arrangement direction of the pixel data corresponding to each of the micro-mirrors 58 corresponds to the main scanning direction. As for the deformation process, for example, a process that shifts the pixel data corresponding to each of the micro-mirrors 58 in the direction opposite to the sub-scanning direction illustrated in FIG. 9 may be used.

Then, the deformed image data deformed in the manner as described above are outputted from the image data deformation unit 61 and stored in the first frame memory 62. Note that the deformed image data are stored in the first frame memory such that the direction in which the addresses of the first frame memory 61 are arranged serially corresponds to the arrangement direction according which the pixel data disposed in the main scanning direction are stored.

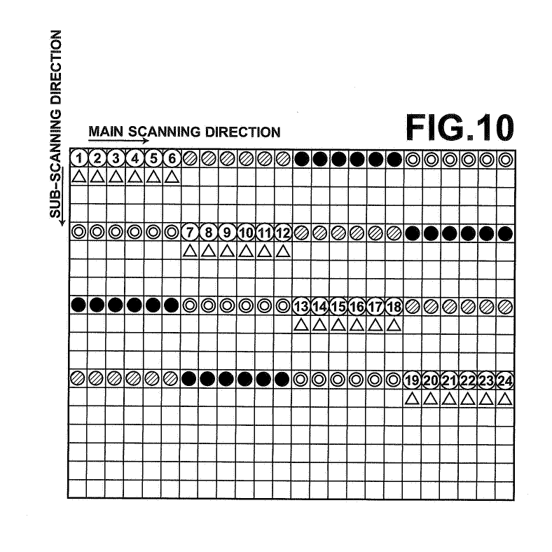

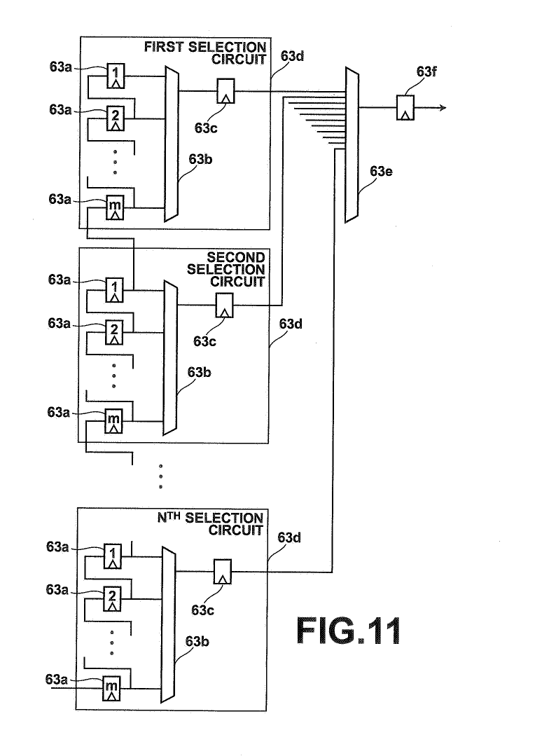

Next, a sorting process is performed, by the pixel data sorting unit 63, on the deformed image data stored in the first frame memory 62 in the manner as described above. More specifically, a process is performed on the pixel data disposed in the main scanning direction in the deformed image data illustrated in FIG. 9, so that pixel data belonging to the same frame data group are collected by selecting and collecting the pixel data arranged every predetermined number of pixel data one by one, and the collected pixel data are disposed serially. By performing the aforementioned process on the pixel data disposed in the main scanning direction sequentially from the left-most pixel data, the deformed image data shown in FIG. 9 are changed to the sorted image data shown in FIG. 10. That is, the sorting process is performed on the deformed image data such that the pixel data belonging to the same frame data group are disposed serially in the main scanning direction. The sorting process describe above may be performed by a program or hardware. More specifically, for example, a configuration may be adopted in which the following are provided: N (six, if sorting is performed, for example, on the deformed image data shown in FIG. 9) selection circuits 63d, which include first m (four, if sorting is performed, for example, on the deformed image data shown in FIG. 9) registers 63a, a first selector 63b that selects and outputs one of the pixel data held by the first m registers 63a; and a second register 63c that holds the pixel data selected by the first selector 63b; a second selector 63e that selects and outputs either one of the pixel data held by the second registers 63c of the N selection circuits 63d; and a third register 63f that holds the pixel data outputted from the second selector 63e, as illustrated in FIG. 11. Then, for example, when performing the sorting process on the deformed image data shown in FIG. 9, for pixel data disposed in the main scanning direction of the deformed image data shown in FIG. 9, four pixel data are outputted from each of the selection circuits 63d and held by the register 63a of each of the selection circuits 63d. That is, in the first selection circuit 63d, pixel data corresponding to circled number 1 shown in FIG. 9 and three consecutive pixel data to the right are held, in the second selection circuit 63d, pixel data corresponding to circled number 2 shown in FIG. 9 and three consecutive pixel data to the right are held, in the third selection circuit 63d, pixel data corresponding to circled number 3 shown in FIG. 9 and three consecutive pixel data to the right are held, and in the N^{th} selection circuit 63d, pixel data corresponding to circled number N shown in FIG. 9 and three consecutive pixel data to the right are held. Then, the pixel data held by the register 1 of the first registers 63a are selected and outputted by the first selection circuit 63b of each of the selection circuits 63d and held by the second register 63c. Then, pixel data held by the second register 63c of each of the selection circuits 63d are sequentially selected and outputted by the second selector 63e and held by the third register 63f, which are then sequentially outputted and stored in the second frame memory 64. Next, the pixel data held by the register 2 of the first registers 63a are selected and outputted by the first selection circuit 63b of each of the selection circuits 63d and held by the second register 63c. Then, pixel data held by the second register 63c of each of the selection circuits 63d are sequentially selected and outputted by the second selector 63e and held by the third register 63f, which are then sequentially outputted and stored in the second frame memory 64. Next, the pixel data held by the registers 3 and 4 of the first registers 63a of each of the selection circuits 63d are read out in the same manner as described above, and stored in the second frame memory 64. Thereafter, the identical process is performed on each row of the pixel data disposed in the main scanning direction to provide sorted image data.

Then, sorted image data in which pixel data are arranged in the manner as illustrated in FIG. 10 are stored in the second frame memory 64. In this case also, the sorted image data are stored in the second frame memory 64 such that the direction in which the addresses of the second frame memory 64 are arranged serially corresponds to the arrangement direction according which the pixel data disposed in the main scanning direction are stored.

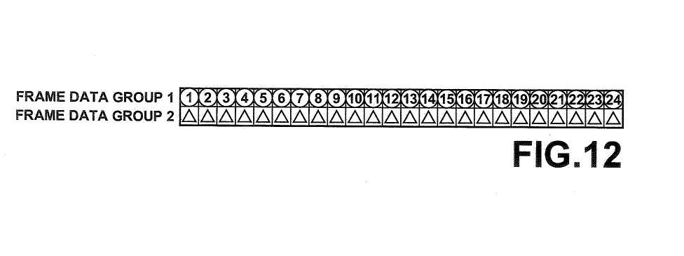

Next, frame data are created by the frame data creation unit 65 based on the sorted image data stored in the second frame memory 64 in the manner as described above. More specifically, the frame data creation unit 65 creates a frame data group 1 illustrated in FIG. 12 by selecting and collecting pixel data corresponding, for example, to the micro-mirrors 58 represented by the circled numbers 1 to 24. Then, the frame data creation unit 65 creates a frame data group 2 illustrated in FIG. 12 by selecting and collecting pixel data corresponding to the triangle marks in FIG. 10. Thereafter, the frame data creation unit 65 creates all groups of frame data by repeating the aforementioned process based on the image data D.

Then, the frame data creation unit 65 sequentially outputs each group of frame data created in the manner as described above to the DMD controller 66, and the DMD controller 66 generates control signals according to the inputted frame data. Note that the frame data describe above are created for DMD 36 of each of the exposure heads 30, and control signals are generated with respect to each DMD 36.

When the control signals for each of the exposing heads 30 are generated in the manner as described above, and a stage drive control signal is outputted to the stage driver 80 from the overall control unit 60, the stage driver 80 moves the moving stage 14 along the guides 20 in the stage moving direction at an intended speed according to the stage drive control signal. When the stage 14 passes under the gate 22, the front edge of the photosensitive material 12 is detected by the sensors 26 attached to the gate 22. Then, the control signals are outputted to the DMD 36 of each of the exposing heads 30 from the DMD controller 66, and plotting by each of the exposing heads 30 is initiated.

Then, the photosensitive material 12 moves with the moving stage 14 at a constant speed. The photosensitive material 12 is scanned by the scanner 24 in the direction opposite to the stage moving direction, and a stripe-shaped exposed region 34 is formed by each of the exposing heads 30.

When the scanning of the photosensitive material 12 by the scanner 24 is completed, and rear edge of the photosensitive material 12 is detected by the sensors 26, the stage 14 is returned to the original position on the uppermost stream of the gate 22 by the stage driver 80 along the guides 20. Thereafter, the stage 14 is moved again along the guides 20 from the upstream to downstream of the gate 22 at a constant speed after a new photosensitive material 12 is placed thereon.

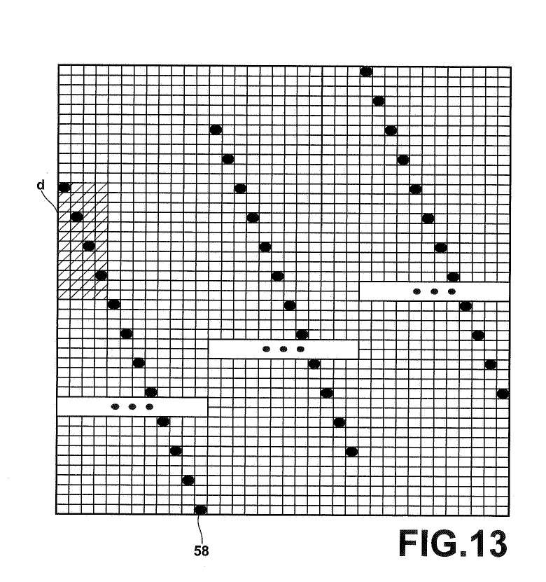

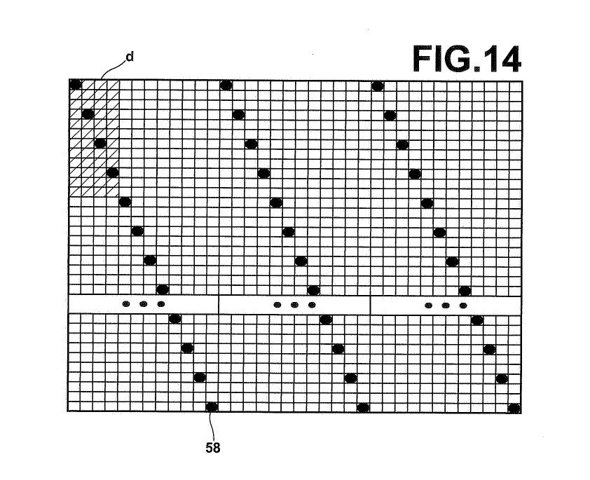

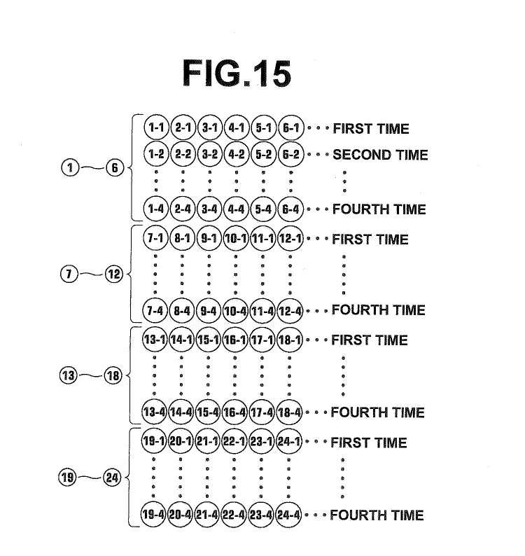

So far the description has been made of a case in which the image data D has the same resolution as that of the image to be exposed on the photosensitive material 14. But, the image data D may have lower resolution than that of the image to be exposed on the photosensitive material 14. That is, a configuration may be adopted in which exposure spots are formed by a plurality of micro-mirrors 58 using single-pixel data d of the image data D, and a single pixel is formed by the plurality of exposed spots. For example, exposure spots may be formed by four micro-mirrors 58 using single-pixel data d of the image data D, and the correspondence relationship, in this case, among the single-pixel data d, micro-mirrors 58, and pixel is illustrated in FIG. 13. In FIG. 13, the slashed portion represents a portion corresponding to the single-pixel data d of the image data D, and this area is exposed with exposure spots exposed by four micro-mirrors 58. When creating frame data for performing the aforementioned exposure, a deformation process is performed on the image data D first, as in the case described above, to generate deformed image data, then a sorting process is performed on the deformed image data, as in the case described above, and the sorted image data are stored in the second frame memory 64 in the same manner as described above. Thereafter, the frame data are created by reading out each of the pixel data stored in the second frame memory 64 a plurality of times. More specifically, in the case where a single pixel is exposed by four micro-mirrors 58 as described above, for example, pixel data corresponding to circled numbers 1 to 6, pixel data corresponding to circled numbers 7 to 12, pixel data corresponding to circled numbers 13 to 18, and pixel data corresponding to circled numbers 19 to 24 shown in FIG. 9 are read out four times respectively to create frame data illustrated in FIG. 15. Here, each of the circled numbers 1 to 24 shown in FIG. 8 is assumed to represent each of the four micro-mirrors in the slashed portion of FIG. 13. Further, the frame data may also be created by reading out pixel data of deformed image data, before sorted, a plurality of times.

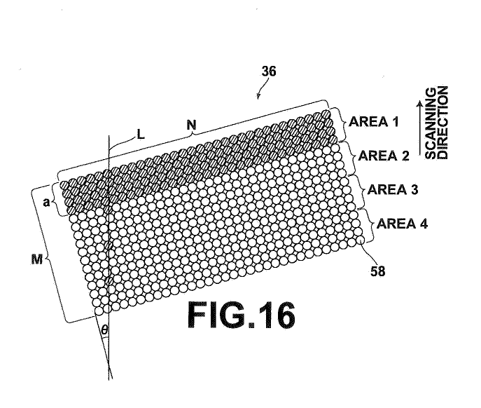

Further, when performing so-called multiple exposures in which, for example, a DMD 36 constituted by N×M micro-mirrors 58 is inclined by an inclination angle θ with respect to the scanning direction as illustrated in FIG. 16, and the same scanning line L is scanned by a plurality of micro-mirrors, same image is exposed by each of the areas 1 to 4, each including N×a micro-mirrors 58, the plot point data inputted to the micro-mirror array of each area are displaced by one pixel in the direction in which the micro-mirror arrays extend with respect to each area in the order in which the exposures are performed.

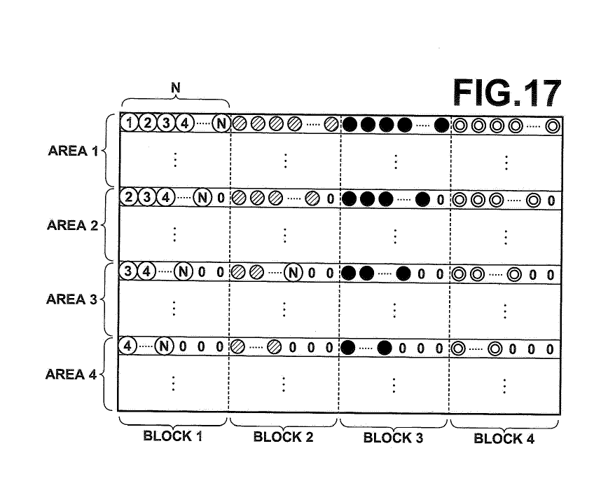

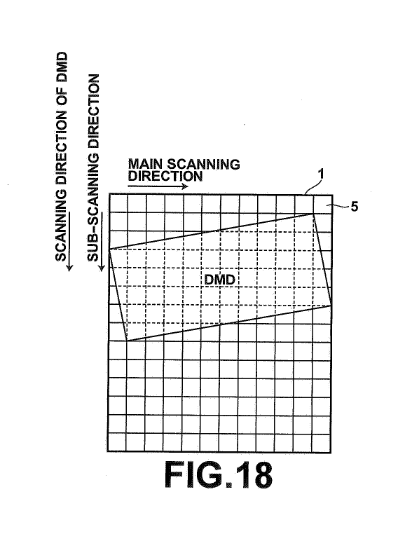

Accordingly, when creating frame data used for the aforementioned exposures, the deformation and sorting processes are performed on the image data corresponding to the micro-mirrors 58 in the area 1 first, as in the case described above, to create sorted image data corresponding to the area 1, as illustrated in FIG. 17. Then, after performing a deformation process on the image data corresponding to the micro-mirrors 58 in the area 1, pixel data right-shifted by single-pixel data, i.e., sorted image data corresponding to the area 2 as illustrated in FIG. 17 are created by performing a sorting process from the second pixel data from the right in the same manner as described above. Thereafter, pixel data right-shifted further by single-pixel data, i.e., sorted image data corresponding to the area 3 as illustrated in FIG. 17 are created by performing a sorting process on the deformed image data corresponding to the area 1 from the third pixel data from the right, and pixel data right-shifted further by single-pixel data, i.e., sorted image data corresponding to the area 4 as illustrated in FIG. 17 are created by performing a sorting process on the deformed image data corresponding to the area 1 from the fourth pixel data from the right. Note that, in the areas 2 to 4, a pixel data value of “0” is inserted a number of times corresponding to the number of times of right-shifting, as illustrated in FIG. 17.

Then, after creating the sorted image data for the areas 1 to 4 in the manner as describe above, partial frame data for each area are created by selecting and collecting pixel data belonging to the same frame data group from each block, and then frame data for the entire DMD 36 are created.

When creating sorted image data for the areas 1 to 4 as described above, if an arrangement is adopted in which, for example, sorted image data of only the area 1 are stored in a memory or the like, and sorted image data for the rest of areas 2 to 4 are created using the sorted image data of the area 1 stored in the memory, then the memory capacity may be reduced, which will lead to cost reduction and faster readout speed from the memory.

Further, in the multiple exposures described above, if, for example, the resolution of the image data in the main scanning direction is lower than that of an image to be exposed, and exposure spots are formed by a plurality of micro-mirrors 58, an arrangement may be made in which plot point data corresponding to the plurality of micro-mirrors 58 are created by reading out N-pixel data of each block in each area a plurality of times, and partial frame data are created using the plot point data.

Still further, in the embodiment described above, the description has been made of a case in which the exposure apparatus includes a DMD as the spatial light modulation device. But, a transmission type spatial light modulation device may also be used other than such a reflective spatial light modulation device.

Further, in the embodiment described above, a so-called flatbed type exposure apparatus is described as an example. But, the present invention may also be applied to a so-called outer drum exposure apparatus having a drum on which the photosensitive material is rolled.

Still further, the photosensitive material 12, which is the exposure target of the embodiment described above, may be a printed board or a display filter. Further, the photosensitive material 12 may be of sheet-like form or continuous length (such as flexible substrate or the like).

The plotting method and apparatus of the present invention may also be applied to plot control of an ink-jet printer or the like. For example, the plot points through jetting of ink may be controlled in the similar manner as described in the present invention. That is, the plotting elements of the present invention may be replaced by the elements that provide plot points through jetting of ink or the like.

1-20. (canceled)

21. A frame data creation method for use in combination with a plot point forming unit which includes a plurality of plotting element arrays disposed in parallel with each other, each having a plurality of plotting elements disposed in a line for forming plot points on a plotting surface, to create frame data including a plurality of plot point data, each corresponding to each of the plotting elements, used when forming an image constituted by a plurality of plot points disposed two-dimensionally on the plotting surface by moving the plot point forming unit relative to the plotting surface in a scanning direction which forms a predetermined inclination angle θ (0°<θ<90°) with an arrangement direction of the plotting element arrays, and sequentially inputting the frame data to the plot point forming unit according to the movement thereof in the scanning direction to sequentially form a group of plot points in time series manner, wherein the frame data are created by obtaining the plurality of plot point data based on image data representing the image in which pixel data corresponding to the plot point data are disposed two-dimensionally in a sub-scanning direction, which corresponds to the scanning direction, and a main scanning direction, which is orthogonal to the sub-scanning direction, the method comprising the steps of:
performing a deformation process on the image data such that the pixel data corresponding to each of the plotting element arrays in the image data are disposed in the main scanning direction; and
creating the frame data by obtaining the plurality of plot point data based on the deformed image data.

22. The frame data creation method as claimed in claim 21, wherein:
the method further comprises the step of storing the pixel data in a memory means to which the deformed image data are stored such that a direction in which addresses of the memory means are arranged serially corresponds to an arrangement direction according which the pixel data corresponding to each of the plotting element arrays are stored; and
the plurality of plot point data are obtained by reading out the stored pixel data from the memory means.

23. The frame data creation method as claimed in claim 21, wherein the deformation process is performed by shifting each of the pixel data corresponding to each of the plotting elements of each of the plotting element arrays in the sub-scanning direction according to the inclination angle.

24. The frame data creation method as claimed in claim 21, wherein:
the method further comprises the step of sorting the pixel data with respect to the scanning direction such that pixel data belonging to a same frame data group, each corresponding to each of the plotting elements of each of the plotting element arrays, are disposed serially in the main scanning direction; and
the frame data are created based on the post-sorting deformed image data.

25. The frame data creation method as claimed in claim 24, wherein: when the resolution of the image data is lower than that of the image to be plotted on the plotting surface,
the method further comprises the step of generating the plot point data, each corresponding to each of the plotting elements, using each of the pixel data of the post-sorting deformed image data a plurality of times; and
the frame data are created using the generated plot point data.

26. The frame data creation method as claimed in claim 24, wherein: when the plot point forming unit is divided into a plurality of segmented regions, and multiple plotting is performed by the plurality of segmented regions,
the method further comprises the step of shifting the post-sorting deformed image data corresponding to each of the segmented regions to the main scanning direction according to the order of the multiple plotting; and
the frame data are created based on the shifted post-sorting deformed image data.

27. A plotting method comprising the steps of:
obtaining each of the frame data groups using the frame data creation method as claimed in claim 21; and
forming the image on the plotting surface by moving the plot point forming unit relative to the plotting surface in the scanning direction, and sequentially inputting each group of the frame data to the plot point forming unit according to the movement thereof in the scanning direction to sequentially form the group of plot points in time series manner.

28. A frame data creation apparatus for use in combination with a plot point forming unit which includes a plurality of plotting element arrays disposed in parallel with each other, each having a plurality of plotting elements disposed in a line for forming plot points on a plotting surface, to create frame data including a plurality of plot point data, each corresponding to each of the plotting elements, used when forming an image constituted by a plurality of plot points disposed two-dimensionally on the plotting surface by moving the plot point forming unit relative to the plotting surface in a scanning direction which forms a predetermined inclination angle θ (0°<θ<90°) with an arrangement direction of the plotting element arrays, and sequentially inputting the frame data to the plot point forming unit according to the movement thereof in the scanning direction to sequentially form a group of plot points in time series manner, wherein the frame data are created by obtaining the plurality of plot point data based on image data representing the image in which pixel data corresponding to the plot point data are disposed two-dimensionally in a sub-scanning direction, which corresponds to the scanning direction, and a main scanning direction, which is orthogonal to the sub-scanning direction, the apparatus comprising:
an image data deformation unit for performing a deformation process on the image data such that the pixel data corresponding to each of the plotting element arrays in the image data are disposed in the main scanning direction; and
a frame data creation unit for creating the frame data by obtaining the plurality of plot point data based on the deformed image data deformed by the image data deformation unit.

29. The frame data creation apparatus as claimed in claim 28, further comprising:
a memory means for storing the deformed image data; and
a memory control means for storing the pixel data in the memory means such that a direction in which addresses of the memory means are arranged serially corresponds to an arrangement direction according which the pixel data corresponding to each of the plotting element arrays are stored,
wherein the frame data creation unit is a unit for reading out from the memory means the pixel data stored therein to obtain the plurality of plot point data.

30. The frame data creation apparatus as claimed in claim 28, wherein the image data deformation unit performs the deformation process by shifting each of the pixel data corresponding to each of the plotting elements of each of the plotting element arrays in the sub-scanning direction according to the inclination angle.

31. The frame data creation apparatus as claimed in claim 28, wherein:
the apparatus further comprises a pixel data sorting unit for sorting the pixel data with respect to the scanning direction such that pixel data belonging to a same frame data group, each corresponding to each of the plotting elements of each of the plotting element arrays, are disposed serially in the main scanning direction; and
the frame data creation unit is a unit for creating the frame data based on the post-sorting deformed image data.

32. The frame data creation apparatus as claimed in claim 31, wherein, when the resolution of the image data is lower than that of the image to be plotted on the plotting surface, the frame data creation unit is a unit for generating the plot point data corresponding to each of the plotting elements using each of the pixel data of the post-sorting deformed image data a plurality of times, and creating the frame data using the generated plot point data.

33. The frame data creation apparatus as claimed in claim 31, wherein, when the plot point forming unit is divided into a plurality of segmented regions, and multiple plotting is performed by the plurality of segmented regions, the frame data creation unit is a unit for shifting the post-sorting deformed image data corresponding to each of the segmented regions to the main scanning direction according to the order of the multiple plotting, and creating the frame data based on the shifted post-sorting deformed image data.

34. A plotting apparatus comprising:
the frame data creation apparatus as claimed in claim 28;
a plot point forming unit for forming a group of plot points constituted by a plurality of plot points on a plotting surface based on the frame data inputted thereto;
a moving means for moving the plot point forming unit relative to the plotting surface in the scanning direction; and
an image forming control unit for sequentially inputting frame data created by the frame data creation apparatus to the plot point forming unit according to the movement of the plot point forming unit in the scanning direction moved by the moving means, and causing the plot point forming unit to form an image constituted by a plurality of plot points disposed two-dimensionally on the plotting surface by forming the group of plot points in time series manner.

35. A recording medium in which a frame data creation program is recorded, the program for causing a computer to perform a method for use in combination with a plot point forming unit which includes a plurality of plotting element arrays disposed in parallel with each other, each having a plurality of plotting elements disposed in a line for forming plot points on a plotting surface, to create frame data including a plurality of plot point data, each corresponding to each of the plotting elements, used when forming an image constituted by a plurality of plot points disposed two-dimensionally on the plotting surface by moving the plot point forming unit relative to the plotting surface in a scanning direction which forms a predetermined inclination angle θ (0°<θ<90°) with an arrangement direction of the plotting element arrays, and sequentially inputting the frame data to the plot point forming unit according to the movement thereof in the scanning direction to sequentially form a group of plot points in time series manner, wherein the frame data are created by obtaining the plurality of plot point data based on image data representing the image in which pixel data corresponding to the plot point data are disposed two-dimensionally in a sub-scanning direction, which corresponds to the scanning direction, and a main scanning direction, which is orthogonal to the sub-scanning direction, wherein the program causes the computer to perform the steps of:
performing a deformation process on the image data such that the pixel data corresponding to each of the plotting element arrays in the image data are disposed in the main scanning direction; and
creating the frame data by obtaining the plurality of plot point data based on the deformed image data.

36. The recording medium as claimed in claim 35, wherein the program causes the computer:
to further perform the step of storing the pixel data in a memory means to which the deformed image data are stored such that a direction in which addresses of the memory means are arranged serially corresponds to an arrangement direction according which the pixel data corresponding to each of the plotting element arrays are stored; and
to perform the step of obtaining the plurality of plot point data by reading out the stored pixel data from the memory means.

37. The recording medium as claimed in claim 35, wherein the deformation process is performed by shifting each of the pixel data corresponding to each of the plotting elements of each of the plotting element arrays in the sub-scanning direction according to the inclination angle.

38. The recording medium as claimed in claim 35, wherein the program causes the computer:
to further perform the step of sorting the pixel data with respect to the scanning direction such that pixel data belonging to a same frame data group, each corresponding to each of the plotting elements of each of the plotting element arrays, are disposed serially in the main scanning direction; and
to perform the step of creating the frame data based on the post-sorting deformed image data.

39. The recording medium as claimed in claim 38, wherein, when the resolution of the image data is lower than that of the image to be plotted on the plotting surface, the program causes the computer:
to further perform the step of generating the plot point data, each corresponding to each of the plotting elements, using each of the pixel data of the post-sorting deformed image data a plurality of times; and
to perform the step of creating the frame data using the generated plot point data.

40. The recording medium as claimed in claim 38, wherein, when the plot point forming unit is divided into a plurality of segmented regions, and multiple plotting is performed by the plurality of segmented regions, the program causes the computer:
to further perform the step of shifting the post-sorting deformed image data corresponding to each of the segmented regions to the main scanning direction according to the order of the multiple plotting; and
to perform the step of crating the frame data based on the shifted post-sorting deformed image data.
